(19) United States
(12) Patent Application Publication
(10) Pub. No.: US 2017/0298191 A1
(43) Pub. Date: Oct. 19, 2017

(54) GRAPHENE PLATELET-BASED POLYMERS AND USES THEREOF

(71) Applicant: Lockheed Martin Corporation, Bethesda, MD (US)

(72) Inventors: Steven Edward Bullock, Canton, GA (US); Sarah M. Simon, Baltimore, MD (US); John B. Stetson,, JR., New Hope, PA (US)

(73) Assignee: Lockheed Martin Corporation, Bethesda, MD (US)

(21) Appl. No.: 15/099,295

(22) Filed: Apr. 14, 2016

(51) Int. Cl. C08G 83/00; B01D 71/40; B01D 67/00; C02F 1/44; B01D 71/82; C02F 101/30; C02F 101/10; C02F 101/12

(52) U.S. Cl. CPC C08G 83/001; C02F 1/44; B01D 71/40; B01D 71/82; B01D 67/0093; C02F 2101/10; C02F 2101/12; C02F 2101/30

(57) ABSTRACT

Provided herein are cross-linked graphene platelet polymers, compositions thereof, filtration devices comprising the cross-linked graphene platelet polymers and/or compositions thereof and method is using and making the same.

### BACKGROUND

Two-dimensional graphene materials such as perforated graphene have been demonstrated as effective in filtration devices. However, the synthesis of these compositions may be costly or time consuming. Thus, there is a need for cheaper, more easily made compositions that can provide similar effects as graphene compositions, as well as new effects.

### SUMMARY

Some embodiments include a membrane comprising a cross-linked graphene platelet polymer comprising a plurality of cross-linked graphene platelets comprising a graphene portion and a cross-linking portion, the cross-linking portion contains a 4 to 10 atom link, and the cross-linked graphene platelet polymer being produced by reaction of an epoxide functionalized graphene platelet and a (meth)acrylate or (meth)acrylamide functionalized cross-linker. In some embodiments, the cross-linked graphene platelet polymer comprises cross-linked graphene platelets comprising a thiol moiety. In some embodiments, the cross-linked graphene platelet polymer further comprises a metal nanocluster. In some embodiments, the cross-linked graphene platelet polymer further comprises a quaternary alkyl-ammonium bromide. In some embodiments, the cross-linked graphene platelet polymer comprises cross-linked graphene platelets containing fluorocarbon functionalization. In some embodiments, each membrane is functionalized in a different manner. In some embodiments, a first filter comprises cross-linked graphene platelets comprising a thiol moiety. In some embodiments, a first filter comprises cross-linked graphene platelets comprising a quaternary alkyl-ammonium bromide. In some embodiments, a first filter comprises cross-linked graphene platelets comprising fluorocarbon.

Some embodiments a membrane comprising include a cross-linked graphene platelet polymer comprising a plurality of cross-linked graphene platelets, (a) comprising a graphene portion and a cross-linking portion, and the cross-linking portion contains a 4 to 10 atom link; or (b) comprising a plurality of graphene platelet portions and a plurality of cross-linking portions bound to the graphene platelet portions, wherein the cross-linking portions provide a spacing of about 1 nanometer between individual graphene platelet portions. In some embodiments, the cross-linked graphene platelet polymer comprises cross-linked graphene platelets comprising a thiol moiety. In some embodiments, the cross-linked graphene platelet polymer further comprises a metal nanocluster. In some embodiments, the cross-linked graphene platelet polymer further comprises a quaternary alkyl-ammonium bromide. In some embodiments, the cross-linked graphene platelet polymer comprises cross-linked graphene platelets containing fluorocarbon functionalization. Some embodiments include a filter module comprising at least two separate membranes of the above embodiments, wherein each membrane is functionalized in a different manner. In some embodiments, a first filter comprises cross-linked graphene platelets comprising a thiol moiety. In some embodiments, a first filter comprises cross-linked graphene platelets comprising a quaternary alkyl-ammonium bromide. In some embodiments, a first filter comprises cross-linked graphene platelets comprising fluorocarbon.

Other embodiments include a method of producing a filter or membrane composition comprising reacting one or more functionalized graphene platelets with one or more di-, tri- or tetra-functional crosslinking compounds. In some embodiments, the functionalized crosslinking compound is di-functionalized. In some embodiments, the crosslinking compound comprises one or more (meth)acrylate or (meth)acrylamide moieties. In some embodiments, the reacting step comprises applying e-beam or UV light to the one or more functionalized graphene platelets with one or more functionalized crosslinking compounds.

Other embodiments include a method of increasing purity of a liquid, comprising contacting a first portion of liquid having an impurity with a filter or membrane comprising a cross-linked graphene platelet polymer of any of the above embodiments to form a second portion of liquid, wherein the second portion of water contains a lower concentration of the impurity. In some embodiments, the liquid is an aqueous physiological liquid. In some embodiments, the liquid is water. In some embodiments, the impurity includes sodium and/or chloride ions. In some embodiments, the impurity includes an antibody. In some embodiments, the second portion of liquid is formed by passing the first portion of liquid through the filter comprising the cross-linked graphene platelet polymer. In some embodiments, the second portion of liquid contains 100-fold or less of the impurity as is found in the first portion of liquid.

Other embodiments include a method of producing a membrane composition comprising oxidizing a graphene platelet with an acid and an oxidizing agent at a temperature between 1 and 10 degrees Celsius to form a functionalized graphene platelet; and reacting one or more functionalized graphene platelets with one or more di-, tri- or tetra-functional crosslinking compounds.

Other embodiments include a method of producing a membrane precursor comprising oxidizing a graphene platelet with an acid and an oxidizing agent at a temperature between 1 and 10 degrees Celsius to form a functionalized graphene platelet; and reacting one or more functionalized graphene platelets to form a capped moiety that is not reactive under ambient conditions, but capable of converting to a reactive moiety upon, e.g., chemical, heat or UV treatment.

Other embodiments include a method of concentrating a composition of interest from a liquid or gas, comprising contacting a first portion of a liquid or gas having a material of interest with a filter comprising a cross-linked graphene platelet polymer of the above embodiments to form a second portion of liquid or gas, wherein the second portion of liquid or gas contains a lower concentration of the material of interest, and collecting the composition of interest that does not pass through the cross-linked graphene platelet polymer. In some embodiments, the liquid or gas is water. In some embodiments, the composition of interest is a rare-earth element.

Additional embodiments include a method of producing a membrane precursor comprising oxidizing a graphene platelet with an acid and an oxidizing agent at a temperature between 1 and 10 degrees Celsius to form a functionalized graphene platelet; and reacting one or more functionalized graphene platelets to form a capped moiety that is not reactive under ambient conditions, but capable of converting to a reactive moiety upon, e.g., chemical, heat or UV treatment.

### BRIEF DESCRIPTION OF THE DRAWINGS

FIG. 1 is an example reaction scheme of some embodiments.

FIG. 2 is an example configuration of a filter module of some embodiments. In these embodiments, there are four different functionalized cross-linked graphene platelet polymer composition layers, each of which is functionalized to remove or reduce the concentration of a different contaminant.

### DETAILED DESCRIPTION

Some embodiments provided herein are cross-linked graphene platelet polymers, compositions thereof, filtration devices comprising the cross-linked graphene platelet polymers and/or compositions thereof and methods for using and making the same.

Cross-Linked Graphene Platelet Polymers

Some of the polymers described herein comprise a graphene portion or moiety and a crosslinking portion or moiety.

The graphene portion or moiety may be a graphene platelet that may be chemically bound directly or indirectly to one or more crosslinking portions or moieties. Crosslinking may be by covalent or other bonding mechanism such as ionic, van der waals, etc.

The graphene portion in some embodiments comprises a reacted graphene platelet.

The graphene platelet may have a very thin but wide aspect ratio. The graphene platelet may comprise several sheets of graphene, for example 1, 2, 3, 4, 5, 6, 7, 8, 9 or 10 sheets of graphene. It is understood that the various sheets are not necessarily the same width, e.g., one or more of the sheets may be a partial sheet that covers only a portion of the sheet in which it is associated with or in contact. For example, a partial sheet may cover about 10%, 20%, 30%, 40%, 50%, 60%, 70%, 80%, 90%, 95%, 98%, 99% of the portion of the sheet in which it is associated with or in contact.

The particle diameter of the graphene platelet may range from sub-micron (for example, about 10 nm, 50 nm, 100 nm, 200 nm, 300 nm, 400 nm, 500 nm, 600 nm, 700 nm, 800 nm, 900 nm, or 1000 nm) up to about 100 microns (for example up to about 1 micron, 2 microns, 3 microns, 4 microns, 5 microns, 6 microns, 7 microns, 8 microns, 9 microns, 10 microns, 20 microns, 30 microns, 40 microns, 50 microns, 60 microns, 70 microns, 80 microns, 90 microns, 100 microns). Various ranges between the disclosed particle diameters may be utilized. It is understood that the graphene platelets will not necessarily be perfect circular particles. Thus, the particle diameter may be measured from the widest points of the graphene platelet.

The size of the graphene platelets may also be expressed as an average size or a plurality of graphene platelets. For example, in some embodiments, the average size of a plurality of graphene platelets used may be about 10 nm, 50 nm, 100 nm, 200 nm, 300 nm, 400 nm, 500 nm, 600 nm, 700 nm, 800 nm, 900 nm, or 1000 nm, about 100 microns (for example up to about 1 micron, 2 microns, 3 microns, 4 microns, 5 microns, 6 microns, 7 microns, 8 microns, 9 microns, 10 microns, 20 microns, 30 microns, 40 microns, 50 microns, 60 microns, 70 microns, 80 microns, 90 microns, 100 microns. The coefficient of variation for the average size may be greater than zero to about 25%. For example, the coefficient of variation may be about 0.01, 0.1, 0.5, 1, 2, 3, 4, 5, 6, 7, 8, 9, 10, 11, 12, 13, 14, 15, 16, 17, 18, 19 or 20.

The graphene platelets in some of the embodiments may be functionalized. This functionalization may result in a direct or indirect chemical bond to the one or more crosslinking portions or moieties, or it may provide additional functionality to the resulting cross-linked graphene platelet polymer.

In some embodiments, the graphene platelet comprises one or more reactive moieties capable of reacting with a crosslinking molecule. In some embodiments, the graphene platelet is functionalized as disclosed in Hunt, A., et al. Adv. Funct. Mater., 22(18), pp. 3950-3957, 2012. The one or more reactive moieties, for example, may be capable of reacting with a (meth)acrylate or (meth)acrylamide moiety, or may be capable of reacting, e.g., with a hydroxyl moiety, a carbonyl moiety, an epoxy moiety, an ether linkage, and phosphide, phosphate, sulfide and/or a sulfate. In some embodiments, the one or more reactive moieties of the graphene platelet can be an epoxy functional group or amine, and graphene/carbon nitride via reaction in a nitrogen plasma. In some embodiments, the one or more reactive moieties is a “capped” moiety that is capable of converting to a reactive moiety upon, e.g., chemical, heat or UV treatment. In various embodiments the graphene has a variable C/O ratio that maximizes the mechanical strength, and, the variation is C/O ratio of 2/1, 5/1, 10/1, 20/1, 30/1, 40/1, 50/1, 60/1 70/1, 80/1 90/1, and 100/1. The speciation of the graphene would be either hydroxyl or epoxy, when reactions with amines or cyanates, can form one pot epoxy or urethane networks. In some embodiments, the one or more reactive moieties are a “capped” moiety that is capable of converting to a reactive moiety upon, e.g., chemical, heat or UV treatment. In some embodiments, the graphene platelet may comprise 1, 2, 3, 4, 5, 6, 7, 8, 9 or 10 reactive moieties. In some embodiments, a plurality of graphene platelets used in the polymer may have an average of about 2, 3, 4, 5, 6, 7, 8, 9 or 10 reactive moieties. The coefficient of variation for this average may be greater than zero to about 25%. For example, the coefficient of variation may be about 0.01, 0.1, 0.5, 1, 2, 3, 4, 5, 6, 7, 8, 9, 10, 11, 12, 13, 14, 15, 16, 17, 18, 19 or 20.

In some embodiments, the graphene platelet comprises one or more functional moieties. These moieties are different from the reactive moieties in that they do not react with the crosslinking molecule, but rather they ultimately impart some functionalization to the resulting cross-linked graphene platelet polymer. Some embodiments utilize functional moieties including thiol moieties, fluorocarbon functionalized areas of the graphene platelet and/or phosphorus, silane and siloxane functional groups.

The crosslinking portions or moieties in some embodiments may be a crosslinking portion that is chemically bound directly or indirectly to two or more graphene portions or moieties. The cross-linked graphene may form ordered layers wherein the crosslinking moiety controls the spacing between ordered layers.

In some embodiments, the crosslinking portion comprises a reacted di-, tri- or tetra-functional crosslinking compound. The functional group may be a (meth)acrylate or (meth)acrylamide moiety, or may be capable of reacting with a hydroxyl or epoxy moiety. In some embodiments, the di-, tri- or tetra-functional crosslinking compound contains the same functional groups. In other embodiments, the functional groups on the di-, tri- or tetra-functional crosslinking compound are different. The crosslinking compound also includes a spacer portion between the functional groups. The spacer group remains in the crosslinking portions or moieties after the functional groups have reacted. For example, the spacer group may comprise 1 to 10 atoms in a linear chain, for example, carbon, oxygen or sulfur atoms, phosphide, phosphate or inorganic moieties as well, silicon and transition metals. The length of the spacer groups will determine the class of the filtered species. The spacer group between adjacent or laterally stacked graphene platelets of 1 to 6 carbons, with a carbon-carbon single bond of 1.54 Å, allows for selectivity of ionic filtration, for species up to 1 nm in diameter. Longer spacers, or branching can enable selectivity for viruses and other pathogens. For example, the spacer may be longer, but still provide spacing between graphene platelets that allows for selective size exclusion of certain viruses and other pathogens of a particular size. The spacing may be determined based on the desired viruses and other pathogen that should be excluded. In some embodiments, the spacer group is a C1-C10 linear chain, or a C3-C20 branched chain. One or more of the carbons may be replaced by an oxygen and/or sulfur atom. The C1-C10 linear chain or C3-C20 branched chain may comprise methylene groups, which may be optionally substituted with one or more halogen of hydroxyl group thiol groups, phosphate, or phosphide.

The crosslinking portions or moieties of the present disclosure provide a spacing between two or more graphene portions or moieties. In some embodiments, the cross-linking portion or moiety provides a 4 to 10 atom link between two or more graphene portions or moieties. In other embodiments, the cross-linking portion provides a 4 to 10 atom link between two or more graphene portions or moieties provide a spacing between individual graphene platelet moieties of about 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3.0, 3.1, 3.2, 3.3, 3.4, or 3.5 nm. The spacing between individual graphene platelet moieties may be determined by molecular modeling of the reacted cross-linking portion, or by microscopic methods, electroacoustic spectroscopy to measure particle and spacing size in aqueous media as well as the zeta potential of the surfaces. Also, x-ray diffraction may be employed to measure inter-plate gallery spacing in lamellar structures. Methods to control the spacing between vertically stacked graphene platelets can employ flexible, e.g., polyphenylene oxide repeat units or rigid carbon spacers with, e.g., polyphenylene or polynorbornene rods to provide a consistent spacer between graphene plates.

In other embodiments, the crosslinking portions or moieties of the present disclosure can include spacer moieties. For example, the crosslinking portion may include moieties to attach to the graphene platelets (e.g., covalently, ionically, etc.) and the spacer moiety. Spacer substances can include polymers, fibers, hydrogels, molecules, nanostructures, nanoparticles and allotropes that are responsive to an environmental stimulus. In some embodiments, the spacer substance is a smart polymer, such as a hygroscopic polymer; a thin polymer that expands when hydrated; or an amorphous polymer, such as a porous amorphous polymer. In some embodiments, the spacer substance comprises electropun fibers that can be swelled upon exposure to a solvent. In some embodiments the spacer substance comprises materials with a high thermal expansion coefficient, which expand or contract in response to a temperature stimulus. In some embodiments, the spacer substance is deliquescent. In some embodiments, the spacers are substantially inert. In some embodiments, the spacers are not inert (i.e., they can be reactive).

Exemplary spacer substances also include structural proteins, collagen, keratin, aromatic amino acids, and polyethylene glycol. Such spacer substances can be responsive to changes in tonicity of the environment surrounding the spacer substance, pi-bonding availability, and/or other environmental stimuli.

In some embodiments, the spacer substance is a piezoelectric, electrostrictive, or ferroelectric magnetic particle. In some embodiments, the magnetic particle comprises a molecular crystal with a dipole associated with the unit cell. In some embodiments, the magnetic particles can be oriented based on an external magnetic field. Exemplary magnetic particles include lithium niobate, nanocrystals of 4-dimethylamino-N-methyl-4-stilbazolium tosylate (DAST)), crystalline polytetrafluoroethylene (PTFE), electrospun PTFE, and combinations thereof.

In some embodiments, the spacer substance heats up faster or slower than its surroundings. Without being bound by theory, it is believed that such embodiments will allow the rate of passage of permeants, or a subset of permeants, across the membrane to be increased and/or decreased.

In some embodiments, spacer substances respond to electrochemical stimuli. For instance, a spacer substance can be an electrochemical material (e.g., lithium ferrophosphate), where a change in oxidation state of the spacer substance (e.g., from 2⁻ to 3⁻) alters permeability of the membrane. In some embodiments, changing the oxidation state of the spacer substances alters the interaction between the spacer substance and potential permeants. In some embodiments, the change in oxidation state results from a redox-type reaction. In some embodiments, the change in oxidation state results from a voltage applied to the membrane.

In some embodiments, the spacer substance comprises contamination structures formed by utilizing a focused ion beam, e.g., to modify heavy levels of contamination on graphene-based material into more rigid structures. For instance, in some embodiments, mobilization and migration of contamination on the surface of the graphene-based material occurs—coupled in some embodiments with some slight beam induced deposition—followed by modification and induced bonding where the beam is applied. In some embodiments, combining contamination structures allows the geometry, thickness, rigidity, and composition of the spacer substance to be tuned to respond to an environmental stimulus (e.g., pressure).

Exemplary spacer substance includes particle substances such as metal nanoparticles (e.g., silver nanoparticles), oxide nanoparticles, octadecyltrichlorosilane nanoparticles, carbon nanotubes, and fullerenes. In some embodiments, the spacer substance includes nanorods, nano-dots (including decorated nano-dots), nanowires, nanostrands, and lacey carbon materials.

In some embodiments, the spacer moiety is responsive to an environmental stimulus, for example, the spacer substance may expand and/or contracts in response to the environmental stimulus. The spacer substance may reversibly expand and/or reversibly contract in response to the environmental stimulus. For instance, conformational changes between trans and cis forms of a spacer substance can alter the effective diameter of the spacer substance (by way of example, a spacer substance could be a polymer with an embedded diazo dye, where exposure to the appropriately colored light alters the volume of the dye based on cis-/trans-conformational changes). In some embodiments, the spacer substance undergoes a physical and/or chemical transformation that is pH-modulated or optically modulated. In some embodiments, the environmental stimulus degrades the spacer substance to alter the effective diameter of the spacer substance.

In some embodiments, the environmental stimulus induces a conformational change in the spacer substance that alters the effective length of the spacer substance. Environmental stimuli may include, for example, changes in temperature, pressure, pH, ionic concentration, solute concentration, tonicity, light, voltage, electric fields, magnetic fields, pi-bonding availability, and combinations thereof.

The polymers described herein may include additional monomeric components, biocompatible silicone, hexamethyl trisiloxane (D3), epoxy, both cyclohexyl epoxies, amenable to UV curing, and epichlorohydrin, amenable to substitution on the carbonyl functionality of graphene. The epichlorohydrin may be curable via thermal methods, and provides a durable, cross-linked graphene polymer. Some polymeric cross-linkers initiators may be curing agents, such as diamines. Other monomers and chain spacers may be included, such as aromatic and alkyl di-carboxylic acids curing via the hydroxyl functionality on the graphene platelets to create polyester cured graphene.

The cross-linked graphene platelet polymers described herein have a sufficient crosslink density to prevent large gaps of uncured section of graphene, which may allow, e.g., salt, to pass unimpeded through greater than about 1 nm holes (or spaces between platelets). In some embodiments, the cross-linked graphene platelet polymers have a crosslink density of 0-0.33 (for example, 0.01, 0.02, 0.03, 0.04, 0.05, 0.06, 0.07, 0.08, 0.09, 0.10, 0.11, 0.12, 0.13, 0.14, 0.15, 0.16, 0.17, 0.18, 0.19, 0.20, 0.21, 0.22, 0.23, 0.24, 0.25, 0.26, 0.27, 0.28, 0.29, 0.30, 0.31, 0.32, or 0.33, and measured by differential scanning calorimetry. In some other embodiments, the cross-linked graphene platelet polymer compositions contain less than about 5%, 4%, 3%, 2%, 1%, 0.5%, 0.1% holes (or spaces between platelets) greater than about 1 nm. In some other embodiments, the cross-linked graphene platelet polymer composition is substantially free of holes (or spaces between platelets) greater than about 1, 1.1, 1.2, 1.3, 1.4, 1.5, 1.6, 1.7, 1.8, 1.9 or 2 nm. In some embodiments, cross-linked graphene platelet polymer composition comprises holes (or spaces between platelets) between 0.5 and 2.0 nm. The other embodiments, the space between platelets changes in response to an environmental stimulus as described herein. The space between platelets may be between 0.5 and 2.0 nm after or before the change in response to an environmental stimulus as described herein.

In other embodiments, the cross-linked graphene platelet polymer composition has a crosslink density sufficient to reduce the sodium content in a 3.5% saline solution by at least 50, 60, 70, 80, 90 or 100 fold when passed through the cross-linked graphene platelet polymer composition having a thickness of about 100 nm. Other embodiments include, e.g., about 50, 60, 70, 80, 90, 100, 110, 120, 130, 140, 150, 160, 170, 180, 190, 200, 210, 220, 230, 240, or 250 nm, or values in between.

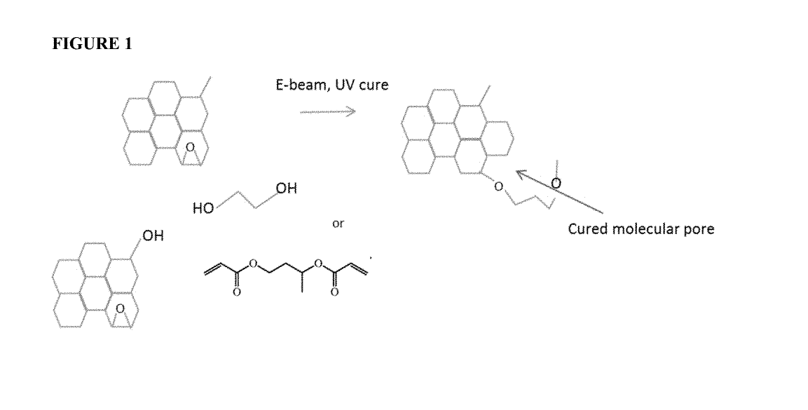

FIG. 1 demonstrates an exemplary reaction scheme of an embodiment of the present disclosure, wherein the graphene platelet comprises a reactive epoxide moiety and the functional crosslinking compounds are di-functional crosslinking compounds containing either hydroxyl moieties or acrylate moieties.

Additional Optional Components of Cross-Linked Graphene Platelet Polymers

As mentioned above, some embodiments of the graphene platelet comprise one or more functional moieties. In addition, the cross-linked graphene platelet polymer compositions may be further functionalized to remove or reduce one or more deleterious contaminant from a liquid or gas passing through the cross-linked graphene platelet polymer composition. For example, the holes (or spaces between platelets) within the cross-linked graphene platelet polymer composition may be patterned with silver nanoclusters that, e.g., deactivate the bacteria. In other embodiments, the cross-linked graphene platelet polymer composition may be further treated with quaternary alkyl-ammonium bromide compounds that, e.g., have been shown to coordinate with the phospholipid shell of viruses. In other embodiments, the cross-linked graphene platelet polymer composition may include ionically or chemisorbed ammonium compounds that are not covalently bound to the cross-linked graphene platelet polymer.

Membranes

The cross-linked graphene platelet polymer may be formed into membranes that remove or reduce one or more deleterious contaminant from a liquid or gas passing through the cross-linked graphene platelet polymer composition. In some embodiments the liquid is water. In some embodiments, the cross-linked graphene platelet polymer compositions may be mounted on a support structure.

In other embodiments, the cross-linked graphene platelet polymer may be formed into membranes that isolate or concentrate one or more desired components from a liquid or gas passing through the cross-linked graphene platelet polymer composition. For example, rare earth ions may be isolated or concentrated from, e.g., seawater by reducing water content where certain components of the seawater (e.g., water) are capable of passing through the cross-linked graphene platelet polymer composition, but the desired compounds, such as rare earth ions, are incapable of passing through the cross-linked graphene platelet polymer composition.

The membranes in some embodiments may include more than one cross-linked graphene platelet polymer composition layers. For example, the different layers may be incorporated into a membrane module, wherein the various layers each has a particular functionality. For example, the filter module comprising at least two separate filters or membranes each comprising a cross-linked graphene platelet polymer composition layer, wherein each filter or membrane is functionalized in a different manner, e.g., wherein the cross-linking moieties generate a spacing of about 1 nanometer between individual graphene platelet moieties, wherein the cross-linking portion contains a 4 to 10 atom link, wherein the cross-linked graphene platelets comprise a thiol moiety, wherein the cross-linked graphene platelets further comprise a metal nanocluster, wherein the cross-linked graphene platelets further comprise a quaternary alkyl-ammonium bromide, or wherein the graphene platelet moieties contains fluorocarbon functionalization.

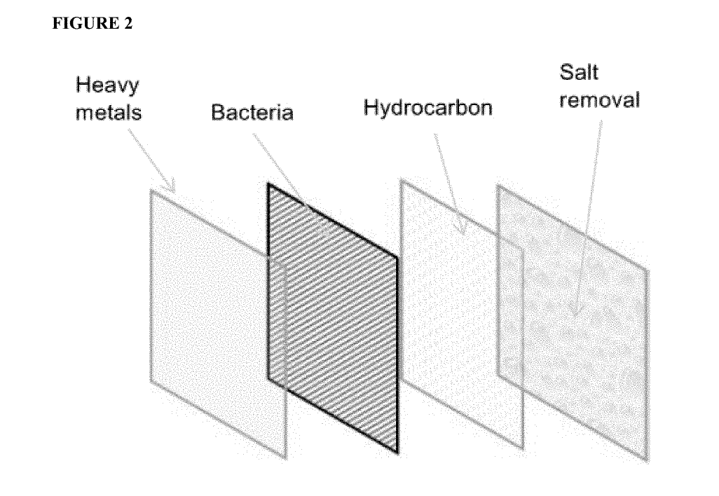

In some embodiments, different layers of the composite membrane module are all incorporated into a modular container, where different modules are incorporated as required to remove/remediate various contaminants as required by the end-user. FIG. 2 provides an exemplary configuration of a filter module of an embodiment of the present disclosure. In this embodiment, there are four different functionalized cross-linked graphene platelet polymer composition layers, each of which is functionalized to remove or reduce the concentration of a different contaminant.

In other embodiments, the composite membrane may be used as a separation/barrier layer or for immunoisolation of a second material that is meant to be isolated from an immune response when placed in a biological system (e.g., an animal such as a mammal). For example, it may be used to separate one environment from another within a biological system. The spacing between individual graphene platelet moieties may be such that certain biological components are excluded from passing through the composite membrane.

In other embodiments, the composite membrane may be used in transdermal applications, wherein the spacing between individual graphene platelet moieties may be such that certain biological components are excluded from passing through the composite membrane.

Methods of Use

The filters and membranes of the disclosure have broad application, including in water filtration, immune-isolation (i.e., protecting substances from an immune reaction), timed drug release (e.g., sustained or delayed release), hemodialysis, and hemofiltration. Some embodiments described herein comprise a method of water filtration, water desalination, water purification, immune-isolation, timed drug release, hemodialysis, or hemofiltration, where the method comprises exposing a membrane to an environmental stimulus, and wherein the membrane comprises a cross-linked graphene platelet polymer described herein.

Some embodiments include a method of increasing the purity of a liquid or gas, comprising contacting a first portion of a liquid or gas having an impurity with a filter or membrane comprising the cross-linked graphene platelet polymer compositions to form a second portion of a liquid or gas, wherein the second portion of a liquid or gas contains a lower concentration of the impurity. In some embodiments, the liquid or gas is liquid water. In other embodiments, the liquid or gas is a liquid in a physiological environment, e.g., in an animal, such as a mammal or human. In some embodiments, the impurity is a salt that may be ionized (e.g., NaCl salt or sodium and chloride ions) or a heavy metal or bacteria (or microorganisms, such as viruses) or a hydrocarbon or a larger biological compounds such as antibodies (whereas the filter or membrane can allow passage of biological compounds such as insulin, proteins and/or other biological material (e.g., RNA, DNA, and/or nucleic acids)). In some embodiments, the second portion of liquid or gas (e.g., water) is formed by passing the first portion of liquid or gas (e.g., water) through the cross-linked graphene platelet polymer compositions or filters or membranes of the present disclosure. In some embodiments, the second portion of liquid or gas (e.g., water) contains 100-fold or less of the impurity as is found in the first portion of liquid or gas (e.g., water).

Some embodiments include a method of concentrating a material of interest from a liquid or gas, comprising contacting a first portion of a liquid or gas having a composition of interest with a filter or membrane comprising the cross-linked graphene platelet polymer compositions to form a second portion of liquid or gas, wherein the second portion of liquid or gas contains a lower concentration of the composition of interest, and collecting the composition of interest that does not pass through the filter or membrane. Some embodiments include a method of concentrating a composition of interest from water by reducing the water content of a solution of that composition. In some embodiments, the composition of interest may be a rare-earth element.

In some embodiments, the cross-linked graphene platelet polymer compositions and the filter or membrane may be used as a pre-filtration device. For example, some embodiments include a method of increasing the purity of water, comprising contacting a first portion of water having an impurity with a filter or membrane comprising the cross-linked graphene platelet polymer compositions to form a second portion of water, wherein the second portion of water contains a lower concentration of the impurity, followed by contacting the second portion of water with a perforated graphene filter or membrane. Some exemplary perforated graphene filters and membranes are described in the art.

Other embodiments include membranes wherein the spacing between individual graphene platelet moieties is such that is allows certain compounds to pass freely, but retards the passage of other, larger compounds. In some embodiments include membranes wherein the spacing and functionalization between individual graphene platelet moieties is such that is allows certain compounds to pass freely, but retards the passage of other compounds that interact with the graphene platelet moieties or a functional compound contained in the cross-linked graphene platelet polymer. In exemplary embodiments, a membrane that allows passage of water but excludes salt ions (e.g. Na⁺ and Cl⁻) can be tuned to allow passage of both water and salt ions. In other exemplary embodiments, the membrane can be tuned to allow passage of biological compounds such as insulin, proteins and/or other biological material (e.g., RNA, DNA, and/or nucleic acids), but to exclude passage of other larger biological compounds such as antibodies. In some embodiments, the membrane can be tuned to be permeable to oxygen and nutrients, but to exclude passage of cells (such as immune cells), viruses, bacteria, antibodies, and/or complements of the immune system. In some embodiments, the membrane can be tuned from one that allows passage of antibodies to one that inhibits passage of antibodies.

Other embodiments include methods of encasing a material and selectively allowing matter of a certain size to contact the encased material. The linked graphene platelet polymer compositions and filters or membranes may be used as encapsulating materials within a biological system, wherein the spacing between individual graphene platelet moieties is such that is allows certain compounds to pass freely, but retards the passage of compounds, such as antibodies from traversing the graphene platelet polymer composition. In exemplary embodiments, a membrane that allows passage of water but excludes salt ions (e.g. Na⁺ and Cl⁻) can be tuned to allow passage of both water and salt ions. In other exemplary embodiments, the membrane can be tuned to allow passage of biological compounds such as insulin, proteins and/or other biological material (e.g., RNA, DNA, and/or nucleic acids), but to exclude passage of other larger biological compounds such as antibodies. In some embodiments, the membrane can be tuned to be permeable to oxygen and nutrients, but to exclude passage of cells (such as immune cells), viruses, bacteria, antibodies, and/or complements of the immune system. In some embodiments, the membrane can be tuned from one that allows passage of antibodies to one that inhibits passage of antibodies.

Methods of Making

The cross-linked graphene platelet polymers may be formed by reacting one or more functionalized graphene platelets with one or more functionalized crosslinking compounds of the present disclosure. In some embodiments, the functionalized graphene platelets of the present disclosure and the functionalized crosslinking compounds of the present disclosure are reacted by heat or radiation (e.g., UV) or e-beam.

Unless defined otherwise, all technical and scientific terms used in this description have the same meaning as commonly understood by those skilled in the relevant art. For convenience, the meaning of certain terms employed in the specification and appended claims are confirmed below to be construed consistently with the understanding of persons of ordinary skill in the art. The singular forms “a,” “an,” and “the” include plural reference unless the context clearly dictates otherwise. As used herein, the term “about” will be understood by persons of ordinary skill in the art and will vary to some extent depending upon the context in which it is used. If there are uses of the term which are not clear to persons of ordinary skill in the art given the context in which it is used, “about” will mean up to plus or minus 10% of the particular parameter.

What is claimed is:

1. A membrane comprising a cross-linked graphene platelet polymer comprising a plurality of cross-linked graphene platelets comprising a graphene portion and a cross-linking portion, the cross-linking portion contains a 4 to 10 atom link, and the cross-linked graphene platelet polymer being produced by reaction of an epoxide functionalized graphene platelet and a (meth)acrylate or (meth)acrylamide functionalized cross-linker.

2. The membrane of claim 1, wherein the cross-linked graphene platelet polymer comprises cross-linked graphene platelets comprising a thiol moiety.

3. The membrane of claim 1, wherein the cross-linked graphene platelet polymer further comprises a metal nanocluster.

4. The membrane of claim 1, wherein the cross-linked graphene platelet polymer further comprises a quaternary alkyl-ammonium bromide.

5. The membrane of claim 1, wherein the cross-linked graphene platelet polymer comprises cross-linked graphene platelets containing fluorocarbon functionalization.

6. A filter module comprising at least two separate membranes of claim 1, wherein each membrane is functionalized in a different manner.

7. The filter module of claim 6, wherein a first filter comprises cross-linked graphene platelets comprising a thiol moiety.

8. The filter module of claim 6, wherein a first filter comprises cross-linked graphene platelets comprising a quaternary alkyl-ammonium bromide.

9. The filter module of claim 6, wherein a first filter comprises cross-linked graphene platelets comprising fluorocarbon.

10. A membrane comprising a cross-linked graphene platelet polymer comprising a plurality of cross-linked graphene platelets,
(a) comprising a graphene portion and a cross-linking portion, and the cross-linking portion contains a 4 to 10 atom link; or
(b) comprising a plurality of graphene platelet portions and a plurality of cross-linking portions bound to the graphene platelet portions, wherein the cross-linking portions provide a spacing of about 1 nanometer between individual graphene platelet portions.

11. The membrane of claim 10, wherein the cross-linked graphene platelet polymer comprises cross-linked graphene platelets comprising a thiol moiety.

12. The membrane of claim 10, wherein the cross-linked graphene platelet polymer further comprises a metal nanocluster.

13. The membrane of claim 10, wherein the cross-linked graphene platelet polymer further comprises a quaternary alkyl-ammonium bromide.

14. The membrane of claim 10, wherein the cross-linked graphene platelet polymer comprises cross-linked graphene platelets containing fluorocarbon functionalization.

15. A filter module comprising at least two separate membranes of claim 10, wherein each membrane is functionalized in a different manner.

16. The filter module of claim 15, wherein a first filter comprises cross-linked graphene platelets comprising a thiol moiety.

17. The filter module of claim 15, wherein a first filter comprises cross-linked graphene platelets comprising a quaternary alkyl-ammonium bromide.

18. The filter module of claim 15, wherein a first filter comprises cross-linked graphene platelets comprising fluorocarbon.

19. A method of producing a filter or membrane composition comprising
reacting one or more functionalized graphene platelets with one or more di-, tri- or tetra-functional crosslinking compounds.

20. The method of claim 19, wherein the functionalized crosslinking compound is di-functionalized.

21. The method of claim 19, wherein the crosslinking compound comprises one or more (meth)acrylate or (meth)acrylamide moieties.

22. The method of claim 19, wherein the reacting step comprises applying e-beam or UV light to the one or more functionalized graphene platelets with one or more functionalized crosslinking compounds.

23. A method of increasing purity of a liquid, comprising
contacting a first portion of liquid having an impurity with a filter or membrane comprising a cross-linked graphene platelet polymer of claim 1 to form a second portion of liquid, wherein the second portion of water contains a lower concentration of the impurity.

24. The method of claim 23, wherein the liquid is an aqueous physiological liquid.

25. The method of claim 23, wherein the liquid is water.

26. The method of claim 23, wherein the impurity includes sodium and/or chloride ions.

27. The method of claim 23, wherein the impurity includes an antibody.

28. The method of claim 23, wherein the second portion of liquid is formed by passing the first portion of liquid through the filter comprising the cross-linked graphene platelet polymer.

29. The method of claim 23, wherein the second portion of liquid contains 100-fold or less of the impurity as is found in the first portion of liquid.

30. A method of producing a membrane composition comprising
oxidizing a graphene platelet with an acid and an oxidizing agent at a temperature between 1 and 10 degrees Celsius to form a functionalized graphene platelet; and
reacting one or more functionalized graphene platelets with one or more di-, tri- or tetra-functional crosslinking compounds.

31. A method of producing a membrane precursor comprising
oxidizing a graphene platelet with an acid and an oxidizing agent at a temperature between 1 and 10 degrees Celsius to form a functionalized graphene platelet; and
reacting one or more functionalized graphene platelets to form a capped moiety that is not reactive under ambient conditions, but capable of converting to a reactive moiety upon, e.g., chemical, heat or UV treatment.

32. A method of concentrating a composition of interest from a liquid or gas, comprising contacting a first portion of a liquid or gas having a material of interest with a filter comprising a cross-linked graphene platelet polymer of claim 1 to form a second portion of liquid or gas, wherein the second portion of liquid or gas contains a lower concentration of the material of interest, and collecting the composition of interest that does not pass through the cross-linked graphene platelet polymer.

33. The method of claim 32, wherein the liquid or gas is water.

34. The method of claim 33, wherein the composition of interest is a rare-earth element.
